(19) United States
(12) Patent Application Publication
(10) Pub. No.: US 2016/0080329 A1
(43) Pub. Date: Mar. 17, 2016

(54) MOBILE TERMINAL AND METHOD THEREOF

(71) Applicant: BEIJING NQ TECHNOLOGY CO., LTD, Beijing (CN)

(72) Inventor: Ji Chen, Beijing (CN)

(21) Appl. No.: 14/888,123

(22) PCT Filed: Dec. 12, 2014
(86) PCT No.: PCT/CN2014/093665

§ 371 Date: Oct. 30, 2015

(30) Foreign Application Priority Data
Dec. 17, 2013 (CN) 201310692720.4

(51) Int. Cl. H04L 29/06; H04L 29/08

(52) U.S. Cl. CPC H04L 63/0428; H04L 63/083; H04L 67/02

(57) ABSTRACT

The present disclosure provides a mobile terminal. The mobile terminal comprises: an encryption password setting unit configured to set an encryption password and encrypt the encryption password; an encryption password management unit configured to back up the encrypted encryption password onto a cloud or acquire the encrypted encryption password from the cloud; a storage encryption unit configured to request the encrypted encryption password from the encryption password management unit, decrypt the encrypted encryption password and encrypt data to be stored with the encryption password; and a read decryption unit configured to request the encrypted encryption password from the encryption password management unit, decrypt the encrypted encryption password and decrypt data to be read with the encryption password. Also provided is a method in a mobile terminal. With the present disclosure, it is possible to reduce the risk of leak of confidential data as a result of data protection on a mobile terminal being cracked without the user's awareness.

### TECHNICAL FIELD

The present disclosure relates to mobile communication, and more particularly, to a mobile terminal and its related method.

### BACKGROUND

Currently, when data is stored in a mobile terminal (e.g., using Android system), it is typically stored in plaintext or in a secure manner provided by the system. Generally, the data stored in a storage medium is secured by a default encryption algorithm and key agreed by the system. Alternatively, data associated with a particular application can be stored using an algorithm and key specific to the application.

From the perspective of security, conventional security measures for data storage can achieve a certain level of security protection. However, the user of the mobile terminal has not been sufficiently involved in protection of his/her own data. Due to the prevalence of the conventional mechanisms, the publicity of the algorithms and the potential derivability of the keys, for either the security mechanisms provided by the system or the application specific security protection measures, there is a risk that the stored data may be cracked without the user's awareness, resulting in a leak of confidential or private data from the mobile terminal.

### SUMMARY

In order to solve the above problem, the present disclosure provides a secure data access mechanism for a mobile terminal. An encryption password can be selected in two ways: it can be set by a user or can be recommended by a functional module. Encryption/decryption security control is applied to data in both directions of write storage and read storage by the mobile terminal. In this way, a secure data access can be achieved.

In particular, the present disclosure provides a secure data access mechanism for a mobile terminal, capable of protecting all write and read storages of data on the terminal. This mechanism allows the user to set an encryption password autonomously, e.g., by selecting the Encryption Password (EP) in in two ways: it can be set by a user or can be recommended by a functional module. Once the EP has been set, it has to be encrypted and backed up remotely over cloud. Before any Date Usage Object (DUO) writes data into a storage medium, a write storage action first invokes an encryption interface to acquire the EP set by the user from the cloud, uses the EP to encrypt all the data passing through the write storage interface with an agreed Encryption Algorithm (EA), such as DES or 3DES, and then writes the encrypted data into the storage medium. When any DUO performs an action of reading data from the storage medium, first the EP is required and then the EP is used for decrypting the encrypted data read from the storage medium. In addition, the backup over the cloud can be made in an encrypted manner, with a certificate signed by the cloud being a public encryption key.

According to a first solution of the present disclosure, a mobile terminal is provided. The mobile terminal comprises: an encryption password setting unit configured to set an encryption password and encrypt the encryption password; an encryption password management unit configured to back up the encrypted encryption password onto a cloud or acquire the encrypted encryption password from the cloud; a storage encryption unit configured to request the encrypted encryption password from the encryption password management unit, decrypt the encrypted encryption password and encrypt data to be stored with the encryption password; and a read decryption unit configured to request the encrypted encryption password from the encryption password management unit, decrypt the encrypted encryption password and decrypt data to be read with the encryption password.

In an embodiment, the mobile terminal further comprises: a log management unit configured to record log information generated during operations of the encryption password setting unit, the encryption password management unit, the storage encryption unit or the read decryption unit.

In an embodiment, the encryption password setting unit is configured to set an encryption password input by a user or an encryption password generated automatically as the encryption password.

In an embodiment, the encryption password setting unit is configured to send the encrypted encryption password to the encryption password management unit via a socket port.

In an embodiment, the encryption password management unit is configured to back up the encrypted encryption password onto the cloud or acquire the encrypted encryption password from the cloud by means of Hyper Text Transfer Protocol Security (HTTPS).

In an embodiment, the storage encryption unit is configured to send a request for the encrypted encryption password to the encryption password management unit and receive the encrypted encryption password from the encryption password management unit via a socket port.

In an embodiment, the read encryption unit is configured to send a request for the encrypted encryption password to the encryption password management unit and receive the encrypted encryption password from the encryption password management unit via a socket port.

In an embodiment, the encryption password setting unit is configured to check the set encryption password to ensure its security.

In an embodiment, the encryption password setting unit is configured to encrypt the encryption password using DES or 3DES algorithm, and each of the storage encryption unit and the read decryption unit is configured to decrypt the encrypted encryption password using DES or 3DES algorithm.

In an embodiment, the log management unit is configured to record the log information at various levels and/or using various recording schemes.

According to a second solution of the present disclosure, a method in a mobile terminal is provided. The method comprises: setting an encryption password and encrypting the encryption password; backing up the encrypted encryption password onto a cloud; acquiring the encrypted encryption password from the cloud when there is data to be stored and/or read and decrypting the encrypted encryption password; and encrypting the data to be stored and/or decrypting the data to be read with the encryption password.

In an embodiment, the method further comprises recording log information generated during the encryption password setting, the encryption password management, the storage encryption or the read decryption.

In an embodiment, an encryption password input by a user or an encryption password generated automatically is set as the encryption password.

In an embodiment, the encrypted encryption password is backed up onto the cloud or acquired from the cloud by means of Hyper Text Transfer Protocol Security (HTTPS).

In an embodiment, the set encryption password is checked to ensure its security.

In an embodiment, the encryption password is encrypted using DES or 3DES algorithm, and the encrypted encryption password is decrypted using DES or 3DES algorithm.

In an embodiment, the log information is recorded at various levels and/or using various recording schemes.

With the present disclosure, it is possible to reduce the risk of leak of confidential data as a result of data protection on a mobile terminal being cracked without the user's awareness.

### BRIEF DESCRIPTION OF THE DRAWINGS

The embodiments of the present disclosure will be described below with reference to the figures, such that the above and other objects, features and advantages will become more apparent, in which:

FIG. 1 is a block diagram of a mobile terminal according to an embodiment of the present disclosure; and

FIG. 2 is a flowchart illustrating a method executed by a mobile terminal according to an embodiment of the present disclosure.

### DETAILED DESCRIPTION OF THE EMBODIMENTS

In the following, the embodiments of the present disclosure will be described in detail with reference to the figures, throughout which the same or similar reference signs will be used for the same or similar structures. In the description below, details and functions irrelevant to the present disclosure will be omitted, so as not to obscure the concept of the present disclosure.

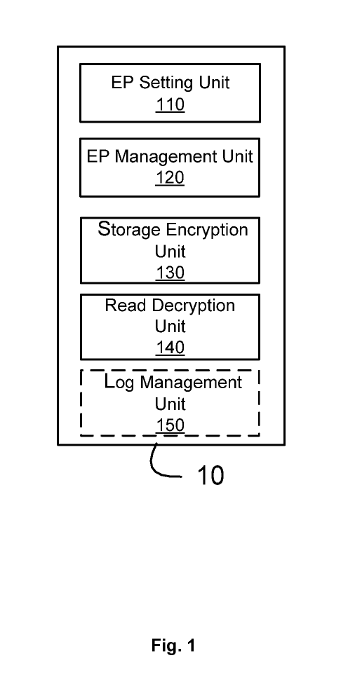

FIG. 1 is a block diagram of a mobile terminal according to an embodiment of the present disclosure. As shown in FIG. 1, the mobile terminal 10 includes an encryption password setting unit 110, an encryption password management unit 120, a storage encryption unit 130 and a read decryption unit 140. Optionally, the mobile terminal 10 can include a log management unit 150. The respective components of the mobile terminal 10 as shown in FIG. 1 will be detailed below.

The encryption password setting unit 110 is configured to set an encryption password and encrypt the encryption password. Preferably, the encryption password setting unit 110 is configured to set an encryption password input by a user or an encryption password generated automatically as the encryption password. More preferably, the encryption password setting unit 110 is configured to check the set encryption password to ensure its security.

The encryption password management unit 120 is configured to back up the encrypted encryption password onto a cloud or acquire the encrypted encryption password from the cloud. For example, the encryption password management unit can back up the encrypted encryption password onto the cloud or acquire the encrypted encryption password from the cloud by means of Hyper Text Transfer Protocol Security (HTTPS).

The storage encryption unit 130 is configured to request the encrypted encryption password from the encryption password management unit, decrypt the encrypted encryption password and encrypt data to be stored with the encryption password.

The read decryption unit 140 is configured to request the encrypted encryption password from the encryption password management unit, decrypt the encrypted encryption password and decrypt data to be read with the encryption password.

The log management unit 150 is configured to record log information generated during operations of the encryption password setting unit, the encryption password management unit, the storage encryption unit or the read decryption unit. Preferably, the log management unit 150 is configured to record the log information at various levels and/or using various recording schemes.

In an embodiment, the encryption password setting unit 110 can send the encrypted encryption password to the encryption password management unit 120 via a socket port. The storage encryption unit 130 can send a request for the encrypted encryption password to the encryption password management unit 120 and receive the encrypted encryption password from the encryption password management unit 120 via a socket port. The read encryption unit 140 can send a request for the encrypted encryption password to the encryption password management unit and receive the encrypted encryption password from the encryption password management unit via a socket port.

In an embodiment, the encryption password setting unit 110 is configured to encrypt the encryption password using DES or 3DES algorithm. Accordingly, each of the storage encryption unit 130 and the read decryption unit 140 is configured to decrypt the encrypted encryption password using DES or 3DES algorithm.

In the following, an application example of the mobile terminal 10 shown in FIG. 1 will be given in detail.

After startup of the mobile terminal, the storage encryption unit 130 and the read decryption unit 140 initialize write storage encryption and read storage description. Then, the encryption password setting unit 110 and the encryption password management unit 120 are initiated to initialize interaction for user setting. The log management unit 150 is initiated to record operation logs for the units 110-140.

The user can set an EP autonomously using the encryption password setting unit 110 and can update and manage an existing EP. Meanwhile, the encryption password setting unit 110 can provide an option for the user to generate a recommended EP using a password generation algorithm provided by the encryption password setting unit 110. The EP complies with a password security specification. For example, the EP can be a combination of uppercase and lowercase letters, digits and special characters and can have a length of 8-16 characters.

After setting the EP, the encryption password setting unit 110 can send a message to the encryption password management unit 120 via a socket port, notifying the encryption password management unit 120 that the EP has been set. The encryption password management unit 120 responds to it. Then, the encryption password setting unit 110 sends the Encrypted EP (EEP) to the encryption password management unit 120. After successfully receiving the EEP, the encryption password management unit 120 sends an acknowledgement message to the encryption password setting unit 110.

For the sake of security, once the communication with the encryption password management unit 120 has completed, the encryption password setting unit 110 should remove the EEP from the memory to prevent it from being leaked.

The encryption password management unit 120 can communicate with a cloud server by means of HTTPS and establish a secure communication channel using a certificate signed by the cloud for sending the EEP to the cloud, such that the EEP can be backed up onto the cloud, thereby preventing the EP from being attacked by any intermediate party.

The storage encryption unit 130 is responsible for monitoring a data write interface on the mobile terminal. Upon monitoring that a Data Usage Object (DUO) generates a data (SD) write storage action, the storage encryption unit 130 will take over the data write action of the DUO and send a message requesting the EP to the encryption password management unit 120 via socket. Upon receiving the message, the encryption password management unit 120 communicates with the cloud to acquire the EEP stored in the cloud by means of HTTPS and sends it to the storage encryption unit 130 via socket. Upon receiving the EEP, the storage encryption unit 130 decrypts it to obtain the EP, and then uses the EA and the EP to encrypt the data SD to obtain the encrypted data ESD. After an integrity check, the storage encryption unit 130 returns the data write action to the DUO for performing the subsequent write storage action. Meanwhile, the storage encryption unit 130 can remove the acquired EEP and EP from the memory.

The read decryption unit 140 is responsible for monitoring a data read interface on the mobile terminal. Upon monitoring that a Data Usage Object (DUO) generates a data (SD) read storage action, the read decryption unit 140 will take over the data read action of the DUO and send a message requesting the EP to the encryption password management unit 120 via socket. Upon receiving the message, the encryption password management unit 120 acquires the EEP stored in the cloud by means of HTTPS and sends it to the read decryption unit 140 via socket. Upon receiving the EEP, the read decryption unit 140 decrypts it to obtain the EP, and then uses the EA and the EP to decrypt the data SD to obtain the decrypted data DSD. After an integrity check, the read decryption unit 140 returns the data read action to the DUO for performing the subsequent data read action. Meanwhile, the read decryption unit 140 can remove the acquired EEP and EP from the memory.

The logs generated by the encryption password setting unit 110, the encryption password management unit 120, the storage encryption unit 130 and the read decryption unit 140 can be recorded at a predetermined position with a log storage scheme set by the log management unit 150. For example, the log management unit 150 can provide three levels of logs (all, warnings and errors) and two log record schemes (plaintext and ciphertext).

With this embodiment, it is possible to reduce the risk of leak of confidential data as a result of data protection on a mobile terminal being cracked without the user's awareness.

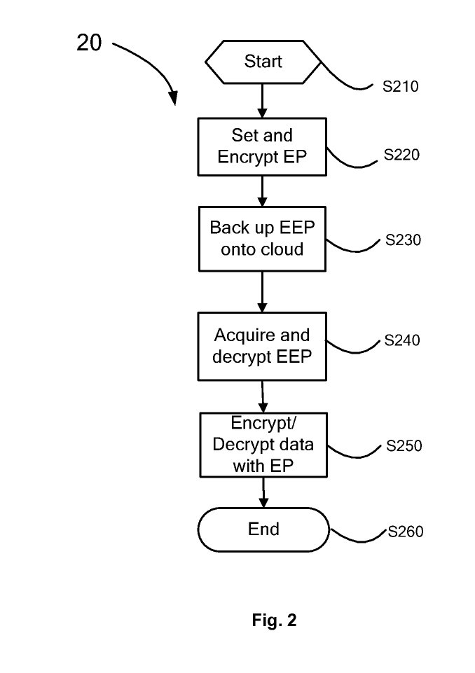

FIG. 2 is a flowchart illustrating a method in a mobile terminal according to an embodiment of the present disclosure. As shown in FIG. 2, the method 20 starts with step S210.

At step S220, an encryption password is set and the encryption password is encrypted. Preferably, an encryption password input by a user or an encryption password generated automatically can be set as the encryption password. For example, the encryption password can be encrypted using DES or 3DES algorithm. More preferably, the set encryption password is checked to ensure its security. The encryption password complies with a password security specification. For example, the encryption password can be a combination of uppercase and lowercase letters, digits and special characters and can have a length of 8-16 characters.

At step S230, the encrypted encryption password is backed up onto a cloud. For example, the encrypted encryption password can be backed up onto the cloud by means of Hyper Text Transfer Protocol Security (HTTPS).

At step S240, when there is data to be stored and/or read, the encrypted encryption password is acquired from the cloud and decrypted. For example, the encrypted encryption password is decrypted using DES or 3DES algorithm.

At step S250, the data to be stored is encrypted and/or the data to be read is decrypted with the encryption password. In particular, when it is monitored that a Data Usage Object (DUO) generates a data (SD) write storage action, the data write action of the DUO is taken over. Then, the EEP stored in the cloud is acquired by means of HTTPS via communication with the cloud. The EEP is decrypted to obtain the EP, and then the EA and the EP are used to encrypt the data SD to obtain the encrypted data ESD. After an integrity check, the data write action is returned to the DUO for performing the subsequent write storage action. Meanwhile, the acquired EEP and EP can be removed from the memory.

On the other hand, when it is monitored that a Data Usage Object (DUO) generates a data (SD) read storage action, the data read action of the DUO is taken over. Then, the EEP stored in the cloud is acquired by means of HTTPS via communication with the cloud. The EEP is decrypted to obtain the EP, and then the EA and the EP are used to decrypt the data SD to obtain the decrypted data DSD. After an integrity check, the data read action is returned to the DUO for performing the subsequent data read action. Meanwhile, the acquired EEP and EP can be removed from the memory.

Alternatively, log information generated during the encryption password setting, the encryption password management, the storage encryption or the read decryption in the steps S220-S250 can be recorded. Preferably, the log information can be recorded at various levels and/or using various recording schemes. For example, three levels of logs (all, warnings and errors) and two log record schemes (plaintext and ciphertext) can be provided.

Finally, the method 20 ends at step S260.

It can be appreciated that the above embodiments of the present disclosure can be implemented in software, hardware or combination thereof. For example, the respective components in the mobile terminal 10 as shown in FIG. 1 can be implemented using various devices, including but not limited to: analog circuits, digital circuits, general purpose processors, Digital Signal Processing (DSP) circuits, programmable processors, Application Specific Integrated Circuits (ASICs), Field Programmable Gate Arrays (FPGAs), Programmable Logical Devices (CPLDs) and the like. Further, the respective components in the mobile terminal 10 can be implemented purely in software, or in combination of hardware and software.

In addition, it can be appreciated by those skilled in the art that the data as described in the embodiments of the present disclosure can be stored in a local database or over distributed databases or in a remote database.

Furthermore, the embodiments of the present disclosure can be implemented as a computer program product. In particular, the computer program product can be a product having a computer readable medium with computer program logics coded thereon. When executed in a computing device, the computer program logics perform operations for implementing the above solutions of the present disclosure. When executed by at least one processor in a computing system, the computer program logics cause the processor to perform the operations (methods) according to the embodiments of the present disclosure. Such arrangement is typically provided as software, codes and/or other data structures provided or coded in a computer readable medium such as an optical medium (e.g., CD-ROM), a floppy disk or a hard disk, or firmware or micro codes in one or more ROM, RAM or PROM chips or other mediums, or downloadable software images or shared databases in one or more modules. The software or firmware or such arrangement can be installed in a computing device to cause one or more processors in the computing device to perform the solutions according to the embodiments of the present disclosure.

The present disclosure has been described above with reference to the embodiments. It is to be noted that other modifications, alternatives and improvements can be made by those skilled in the art without departing from the scope and spirit of the present disclosure. Therefore, the scope of the present disclosure is not limited to the above embodiments. Rather, it is defined only by the claims as attached.

What is claimed is:

1. A mobile terminal, comprising:
an encryption password setting unit configured to set an encryption password and encrypt the encryption password;
an encryption password management unit configured to back up the encrypted encryption password onto a cloud or acquire the encrypted encryption password from the cloud;
a storage encryption unit configured to request the encrypted encryption password from the encryption password management unit, decrypt the encrypted encryption password and encrypt data to be stored with the encryption password; and
a read decryption unit configured to request the encrypted encryption password from the encryption password management unit, decrypt the encrypted encryption password and decrypt data to be read with the encryption password.

2. The mobile terminal of claim 1, further comprising:
a log management unit configured to record log information generated during operations of the encryption password setting unit, the encryption password management unit, the storage encryption unit or the read decryption unit.

3. The mobile terminal of claim 1, wherein the encryption password setting unit is configured to set an encryption password input by a user or an encryption password generated automatically as the encryption password.

4. The mobile terminal of claim 1, wherein the encryption password setting unit is configured to send the encrypted encryption password to the encryption password management unit via a socket port.

5. The mobile terminal of claim 1, wherein the encryption password management unit is configured to back up the encrypted encryption password onto the cloud or acquire the encrypted encryption password from the cloud by means of Hyper Text Transfer Protocol Security (HTTPS).

6. The mobile terminal of claim 1, wherein the storage encryption unit is configured to send a request for the encrypted encryption password to the encryption password management unit and receive the encrypted encryption password from the encryption password management unit via a socket port.

7. The mobile terminal of claim 1, wherein the read decryption unit is configured to send a request for the encrypted encryption password to the encryption password management unit and receive the encrypted encryption password from the encryption password management unit via a socket port.

8. The mobile terminal of claim 1, wherein the encryption password setting unit is configured to check the set encryption password to ensure its security.

9. The mobile terminal of claim 1, wherein
the encryption password setting unit is configured to encrypt the encryption password using DES or 3DES algorithm, and
the storage encryption unit and the read decryption unit are configured to decrypt the encrypted encryption password using DES or 3DES algorithm.

10. The mobile terminal of claim 2, wherein the log management unit is configured to record the log information at various levels and/or using various recording schemes.

11. A method implemented by a mobile terminal, comprising:
setting an encryption password and encrypting the encryption password;
backing up the encrypted encryption password onto a cloud;
acquiring the encrypted encryption password from the cloud when there is data to be stored and/or read and decrypting the encrypted encryption password; and
encrypting the data to be stored and/or decrypting the data to be read with the encryption password.

12. The method of claim 11, further comprising recording log information generated during the operation of encryption password setting, the encryption password management, the storage encryption or the read decryption.

13. The method of claim 11, wherein an encryption password input by a user or an encryption password generated automatically is set as the encryption password.

14. The method of claim 11, wherein the encrypted encryption password is backed up onto the cloud or acquired from the cloud by means of Hyper Text Transfer Protocol Security (HTTPS).

15. The method of claim 11, wherein the set encryption password is checked to ensure its security.

16. The method of claim 11, wherein the encryption password is encrypted using DES or 3DES algorithm, and the encrypted encryption password is decrypted using DES or 3DES algorithm.

17. The method of claim 12, wherein the log information is recorded at various levels and/or using various recording schemes.
